(19) United States
(12) Patent Application Publication
(10) Pub. No.: US 2025/0364693 A1
(43) Pub. Date: Nov. 27, 2025

(54) BUSBAR

(71) Applicant: YAZAKI CORPORATION, Tokyo (JP)

(72) Inventors: Kazuyoshi Kagami, Shizuoka (JP); Mizuki Shirai, Shizuoka (JP); Daiki Kobayashi, Shizuoka (JP)

(73) Assignee: YAZAKI CORPORATION, Tokyo (JP)

(21) Appl. No.: 19/187,459

(22) Filed: Apr. 23, 2025

(30) Foreign Application Priority Data
May 27, 2024 (JP) 2024-085680

(51) Int. Cl. H01M 50/503; H01M 10/6551; H01M 50/517; H01M 50/522

(52) U.S. Cl. CPC H01M 50/503; H01M 10/6551; H01M 50/517; H01M 50/522

(57) ABSTRACT

A busbar includes a pair of connection portions configured to be connected to a connection object, a conductor portion between the pair of connection portions, and a heat dissipation fin protruding from the conductor portion. An area of a cross section orthogonal to a current path in a first region in which the heat dissipation fin is provided is smaller than an area of a cross section orthogonal to the current path in a second region that is outside the first region and includes the connection portions.

### CROSS-REFERENCE TO RELATED APPLICATIONS

This application is based on and claims priority under 35 USC 119 from Japanese Patent Application No. 2024-085680 filed on May 27, 2024, the entire content of which is incorporated herein by reference.

### TECHNICAL FIELD

The present disclosure relates to a busbar.

### BACKGROUND ART

A busbar that connects terminals of secondary batteries adjacent to each other in a battery pack is known to include a plate-shaped base portion formed with a through hole through which a terminal is inserted, and a plurality of heat dissipation fins provided perpendicular to the base portion as disclosed in, for example, JP2013-105674A. In the busbar described in JP2013-105674A, by providing the heat dissipation fins on the base portion, the surface area and the cross-sectional area of the busbar are increased, and heat dissipation effect of the busbar is enhanced.

However, in the busbar described in JP2013-105674A, since the heat dissipation fin is added to the base portion, there is a trade-off between the heat dissipation effect and the weight. The heat dissipation effect is enhanced, while the weight is also increased.

In view of the above circumstances, an object of the present disclosure is to provide a busbar capable of enhancing the heat dissipation effect while restricting an increase in weight.

### SUMMARY OF INVENTION

According to the present disclosure, a busbar includes a pair of connection portions configured to be connected to a connection object, a conductor portion between the pair of connection portions, and a heat dissipation fin protruding from the conductor portion. An area of a cross section orthogonal to a current path in a first region in which the heat dissipation fin is provided is smaller than an area of a cross section orthogonal to the current path in a second region that is outside the first region and includes the connection portions.

According to the present disclosure, it is possible to enhance the heat dissipation effect while restricting an increase in weight.

### BRIEF DESCRIPTION OF DRAWINGS

FIG. 1 is a perspective view showing a busbar according to an embodiment of the present disclosure;

FIG. 2 is a sectional view showing the busbar shown in FIG. 1;

FIG. 3 is a perspective view showing a connection portion of the busbar shown in FIG. 1;

FIG. 4 is a perspective view showing a busbar according to a first comparative example;

FIG. 5 is a sectional view showing a busbar according to a second comparative example;

FIG. 6 is a diagram showing a simulation result of saturation temperature of the busbar according to the first comparative example shown in FIG. 4;

FIG. 7 is a diagram showing a simulation result of saturation temperature of the busbar according to the second comparative example shown in FIG. 5;

FIG. 8 is a diagram showing a simulation result of saturation temperature of a busbar having the same shape and the same dimensions as those of the busbar according to the embodiment shown in FIG. 1 and having a surface not subjected to alumite treatment;

FIG. 9 is a diagram showing a simulation result of saturation temperature of the busbar according to the embodiment shown in FIG. 1;

FIG. 10 is a perspective view showing a busbar according to another embodiment of the present disclosure; and

FIG. 11 is a graph showing simulation results of saturation temperature of the busbar shown in FIG. 10 and the saturation temperature of the busbar according to the first comparative example shown in FIG. 4.

### DESCRIPTION OF EMBODIMENTS

Hereinafter, the present disclosure will be described with reference to preferred embodiments. The present disclosure is not limited to the embodiments shown below, and the embodiments shown below can be appropriately changed within a scope not departing from the spirit of the present disclosure. In the embodiments to be described below, a part of configurations may be not described or shown in the drawings, and regarding details of the omitted techniques, publicly known or well-known techniques will be appropriately applied as long as there is no contradiction with the contents to be described below.

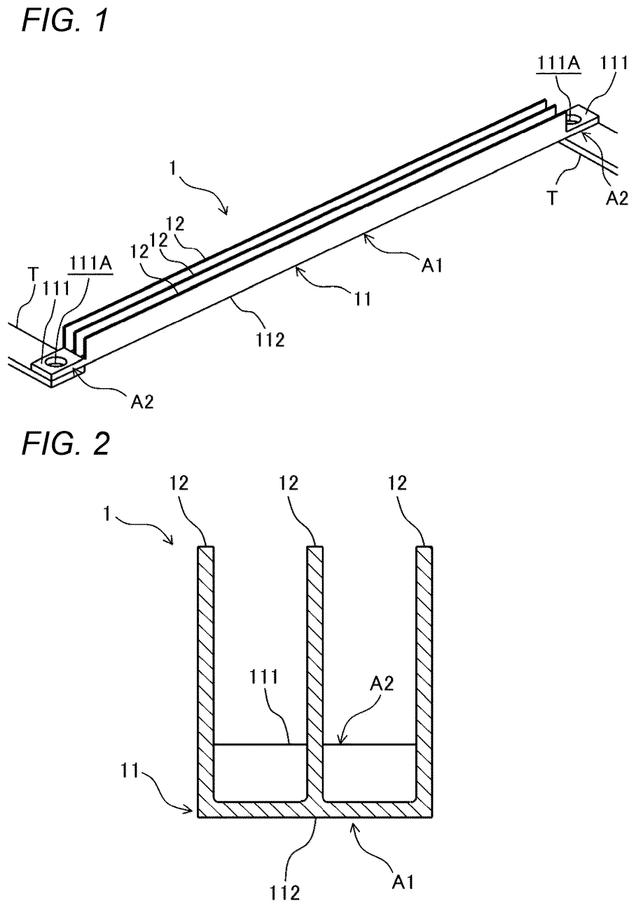

FIG. 1 is a perspective view showing a busbar 1 according to an embodiment of the present disclosure. The busbar 1 shown in FIG. 1 is a conductor that connects terminals T of adjacent secondary batteries in a battery pack mounted on an electric vehicle such as an electric vehicle or a hybrid vehicle, and a high voltage large current flows through the busbar 1 when energized. The application of the busbar 1 is not limited to a secondary battery of an electric vehicle, but may also include distribution boards, control boards, and the like.

The busbar 1 is an aluminum casting having a surface subjected to alumite treatment, and includes a base portion 11 having a rectangular plate shape and a plurality of heat dissipation fins 12 provided integrally with the base portion 11. The base portion 11 includes a pair of connection portions 111 and a conductor portion 112 between the pair of connection portions 111. The conductor portion 112 extends between the pair of connection portions 111, and the connection portions 111 are provided at end portions of the busbar 1 in a longitudinal direction, respectively. In the busbar 1, a current flows along the longitudinal direction of the busbar 1. That is, a current path of the busbar 1 extends along the longitudinal direction of the busbar 1.

The connection portion 111 is a rectangular plate-shaped portion to come into contact with the terminal T of the secondary battery, and has a plate thickness relatively larger than that of the conductor portion 112. In the present embodiment, the plate thickness of the connection portion 111 is 7 mm, and a width (dimension in a direction orthogonal to the current path) of the connection portion 111 is 20 mm. The plate thickness of the connection portion 111 is preferably 5 mm or more and 10 mm or less, and the width of the connection portion 111 is preferably 10 mm or more and 30 mm or less.

FIG. 2 is a sectional view showing the busbar 1 shown in FIG. 1. This drawing shows a cross section of the busbar 1 cut along the direction orthogonal to the longitudinal direction (current path) at a middle portion in the longitudinal direction.

As shown in FIG. 2, the plate thickness of the conductor portion 112 is relatively smaller than the plate thickness of the connection portion 111. The plurality of heat dissipation fins 12 protrude from one plate surface of the conductor portion 112 in a direction orthogonal to the plate surface. In the present embodiment, the plate thickness of the conductor portion 112 is 3.7 mm, and a width (dimension in the direction orthogonal to the current path) of the conductor portion 112 is 20 mm. The plate thickness of the conductor portion 112 is preferably 1 mm or more and 5 mm or less, and the width of the conductor portion 112 is preferably 10 mm or more and 30 mm or less.

The plurality of (three in the present embodiment) heat dissipation fins 12 are provided on the one plate surface of the conductor portion 112 so as to be arranged at equal intervals in a width direction (direction orthogonal to the current path) of the plate surface and extend along the longitudinal direction of the plate surface. As shown in FIG. 1, each heat dissipation fin 12 is formed in a rectangular plate shape, and extends from a boundary between the conductor portion 112 and one connection portion 111 to a boundary between the conductor portion 112 and the other connection portion 111. In the present embodiment, a height (width) of each heat dissipation fin 12 is 20 mm, and a plate thickness of each heat dissipation fin 12 is 3.7 mm. The height of each heat dissipation fin 12 is preferably 10 mm or more and 30 mm or less, and the plate thickness of each heat dissipation fin 12 is preferably 1 mm or more and 5 mm or less.

A step is formed at a boundary between the one plate surface of the conductor portion 112 and one plate surface of the connection portion 111, and the other plate surface of the conductor portion 112 and the other plate surface of the connection portion 111 are flush without a step. The other plate surface of the connection portion 111 is in contact with one surface of the terminal T (see FIG. 1).

In the present embodiment, the terminal T is a female terminal, and a screw hole (not shown) to which a bolt (not shown) is fastened is formed in the terminal T. Correspondingly, a through hole 111A through which the bolt is inserted is formed in the connection portion 111, so that the connection portion 111 and the terminal T are fastened by the bolt. When the terminal T is a male terminal, a bolt (not shown) protruding from the terminal T is inserted into the through hole 111A, and the connection portion 111 and the terminal T are fastened by the bolt and a nut (not shown).

Here, an area of a cross section of the busbar 1 in the direction orthogonal to the current path (hereinafter, referred to as a cross-sectional area) is different between a first region A1 in which the heat dissipation fins 12 are provided and a second region A2 in which the heat dissipation fins 12 are not provided. The cross-sectional area of the first region A1 is smaller than the cross-sectional area of the second region A2. In the present embodiment, a region formed by the conductor portion 112 and the heat dissipation fins 12 is the first region A1, and a region formed by only the connection portion 111 is the second region A2.

In the present embodiment, the cross-sectional area of the first region A1 is 100 mm², while the cross-sectional area of the second region A2 is 140 mm². The cross-sectional area of the first region A1 is the sum of a cross-sectional area of the conductor portion 112 and a cross-sectional area of the heat dissipation fins 12.

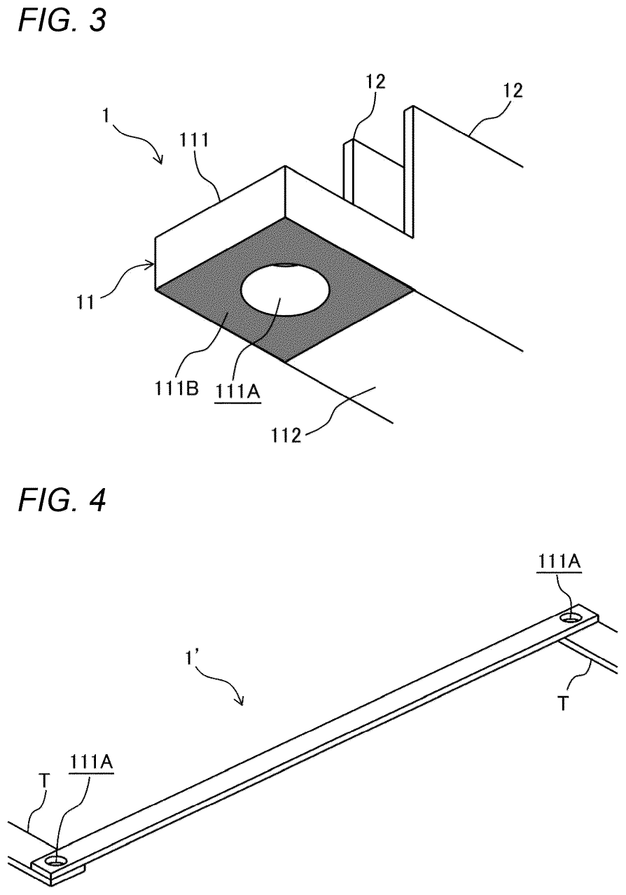

FIG. 3 is a perspective view showing the connection portion 111 of the busbar 1 shown in FIG. 1. Here, the other plate surface of the connection portion 111 is a surface (hereinafter, contact surface) 111B that comes into contact with the terminal T, and the contact surface 111B is not subjected to the alumite treatment. This ensures conduction between the contact surface 111B of the connection portion 111 and the terminal T. On the other hand, the entire surface of the connection portion 111 other than the contact surface 111B, the entire surface of the conductor portion 112, and the entire surface of each heat dissipation fin 12 are subjected to the alumite treatment. This ensures insulation of the surface of the busbar 1 excluding the contact surface 111B. In addition, since the emissivity of the surface of the busbar 1 is increased, the effect of natural cooling by radiation (cooling in a windless state where no wind is forced from outside) is enhanced.

Here, the amount of heat dissipated by radiation is defined by the following equation (1) according to the Stefan-Boltzmann law. According to the Stefan-Boltzmann law, the higher the emissivity, the greater the heat dissipation effect by radiation.

$$\begin{matrix}[ Math . 1 ] & \\ Q = 5.67 \times {10}^{- 8} ϵ {T}^{4} & ( 1 )\end{matrix}$$

where Q is the amount of dissipated heat [W/m²], ε is the emissivity, and T is the temperature [K].

In general, metal has a low emissivity ε, and it is difficult to enhance the heat dissipation effect by radiation. Therefore, in the present embodiment, the busbar 1 is an aluminum casting, the surface area is enlarged by the heat dissipation fins 12, and the entire surface of the busbar 1 other than the contact surface 111B is subjected to the alumite treatment, so that the emissivity ε is increased and the heat dissipation effect by radiation is enhanced.

FIG. 4 is a perspective view showing a busbar 1′ according to a first comparative example. As shown in this drawing, the busbar 1′ according to the first comparative example is a plate-shaped conductor having a uniform plate thickness, and is not provided with the heat dissipation fins 12. The busbar 1′ is a long rectangular conductor having a plate thickness of 7 mm and a width of 20 mm, and is an aluminum casting as in the above embodiment. A cross-sectional area of the busbar 1′is 140 mm². The surface of the busbar 1′ according to the first comparative example is not subjected to the alumite treatment.

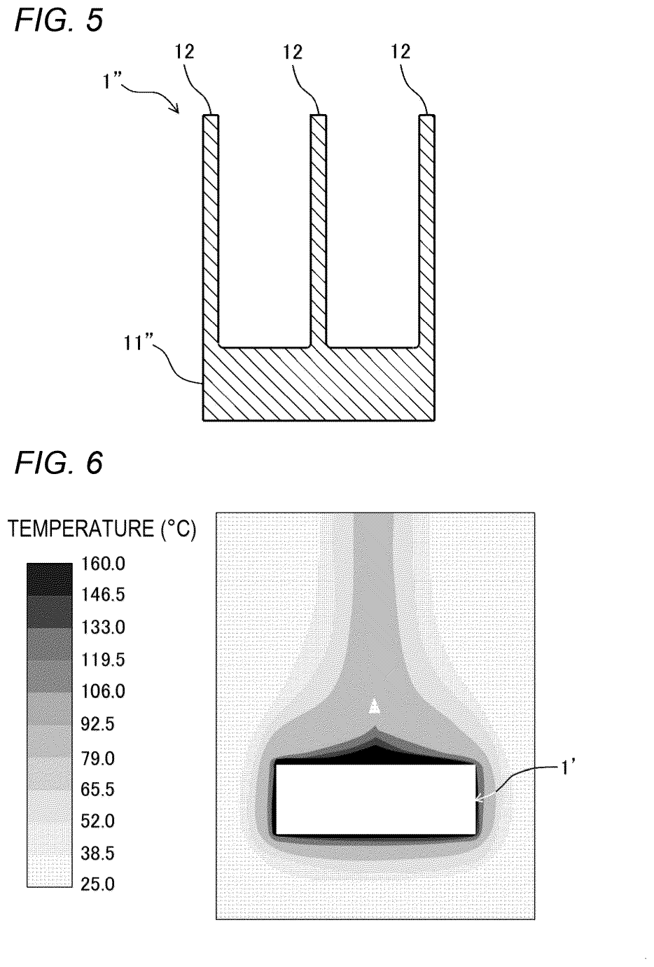

FIG. 5 is a sectional view showing a busbar 1″ according to a second comparative example. As shown in the drawing, the busbar 1″ according to the second comparative example is an aluminum casting including a rectangular plate-shaped base portion 11″ having a uniform plate thickness and a plurality of heat dissipation fins 12 provided on one surface of the base portion 11″. Similarly to the above embodiment, the plurality of heat dissipation fins 12 are arranged in parallel at equal intervals in the width direction of the one surface of the base portion 11″ and extend along the longitudinal direction of the one surface. A plate thickness of the base portion 11″ is 7 mm, a width of the base portion 11″ is 20 mm, a height of the heat dissipation fins 12 is 20 mm, and a plate thickness of the heat dissipation fins 12 is 3.7 mm. The surface of the busbar 1″ according to the second comparative example is not subjected to the alumite treatment.

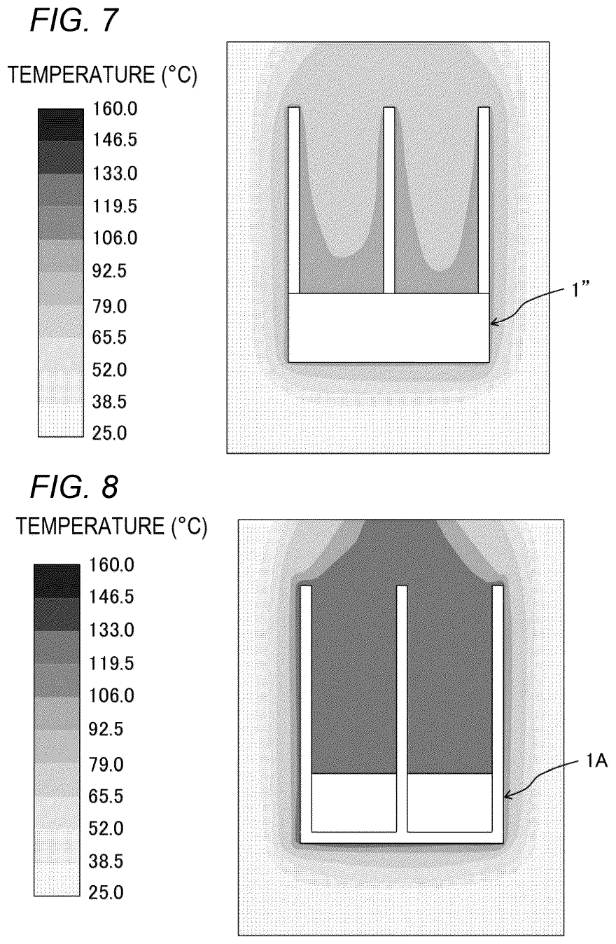

FIG. 6 is a diagram showing a simulation result of saturation temperature (temperature in a thermally saturated state) of the busbar 1′ according to the first comparative example shown in FIG. 4. FIG. 7 is a diagram showing a simulation result of saturation temperature of the busbar 1″ according to the second comparative example shown in FIG. 5. FIG. 8 is a diagram showing a simulation result of saturation temperature of a busbar 1A having the same shape and the same dimensions as those of the busbar 1 according to the embodiment shown in FIG. 1 and having a surface not subjected to the alumite treatment.

In the simulations shown in FIGS. 6 to 8, the saturation temperature when a current of 450 A was passed through the busbar 1′, 1″, 1A in an environment of an air temperature of 20° C. was analyzed using cooling simulation software for electronic components (Ansys (registered trademark) Icepak). In FIGS. 6 to 8, the temperature is indicated by density. The higher the temperature, the higher the density.

From the simulation results shown in FIG. 6, it was confirmed that the saturation temperature of the busbar 1′ according to the first comparative example was 149.6° C. From the simulation results shown in FIG. 7, it was confirmed that the saturation temperature of the busbar 1″ according to the second comparative example was 107.9° C. Further, from the simulation results shown in FIG. 8, it was confirmed that the saturation temperature of the busbar 1A having the same shape and the same dimensions as those of the busbar 1 according to the embodiment shown in FIG. 1 and not subjected to the alumite treatment was 131.7° C., which was about 18° C. lower than that of the busbar 1′ according to the first comparative example.

Here, the cross-sectional area of the busbar 1 according to the embodiment shown in FIG. 1 is 100 mm², which is about 30% smaller than the cross-sectional area (140 mm²) of the busbar 1′ according to the first comparative example. Therefore, from the simulation results shown in FIGS. 6 and 8, it was confirmed that as compared with the busbar 1′ according to the first comparative example, the busbar 1A having the same shape and the same dimensions as those of the busbar 1 according to the embodiment and not subjected to the alumite treatment can achieve approximately 30% weight reduction and approximately 18° C. reduction in saturation temperature.

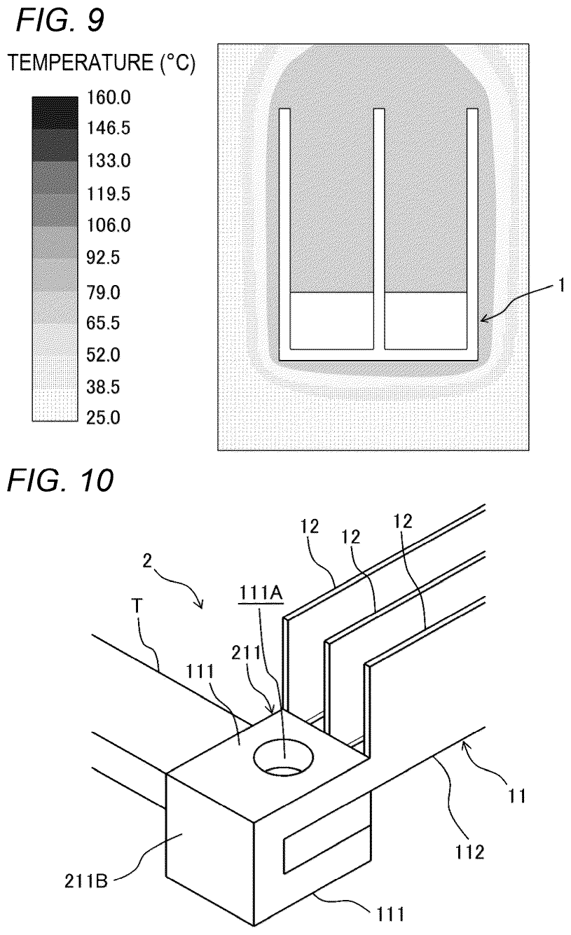

FIG. 9 is a diagram showing a simulation result of saturation temperature of the busbar 1 according to the embodiment shown in FIG. 1. In the simulation of FIG. 9, the saturation temperature when a current of 450 A was passed through the busbar 1 in an environment of an air temperature of 20° C. was analyzed using cooling simulation software for electronic components. In FIG. 9, the temperature is indicated by density. The higher the temperature, the higher the density.

In the simulation illustrated in FIG. 9, the saturation temperature of the busbar 1 in which the entire surface other than the contact surface 111B was subjected to the alumite treatment was analyzed. In the simulation shown in FIG. 9, the emissivity & of the busbar 1 was set to 0.9. In this regard, in the simulation shown in FIG. 8, the emissivity ε of the busbar 1A was set to 0.04. The simulation conditions shown in FIGS. 8 and 9 are the same except for the emissivity ε.

From the simulation results shown in FIG. 9, it was confirmed that the saturation temperature of the busbar 1 in which the entire surface other than the contact surface 111B was subjected to the alumite treatment was 91.2° C. From the simulation results shown in FIGS. 8 and 9, it was confirmed that the saturation temperature was lowered by approximately 40°° C. by performing the alumite treatment on the entire surface other than the contact surface 111B to increase the emissivity ε.

As described above, in the busbar 1 according to the present embodiment, the area of the cross section orthogonal to the current path in the first region A1 in which the heat dissipation fins 12 are provided is smaller than the area of the cross section in the direction orthogonal to the current path in the second region A2 that is outside the first region A1 and includes the connection portion 111. Accordingly, the heat dissipation effect of the busbar 1 can be enhanced by increasing the surface area by the heat dissipation fins 12 while reducing an increase in the weight of the busbar 1.

In the busbar 1 according to the present embodiment, the pair of connection portions 111, the conductor portion 112, and the heat dissipation fins 12 are made of aluminum, and the surfaces of the conductor portion 112 and the heat dissipation fins 12 are subjected to the alumite treatment. Accordingly, the emissivity ε of the busbar 1 can be enhanced in addition to the increase in the surface area by the heat dissipation fins 12, so that the heat dissipation effect of the busbar 1 can be further enhanced.

In the busbar 1 according to the present embodiment, other than the contact surfaces 111B with the terminals T, the surfaces of the pair of connection portions 111 are subjected to the alumite treatment. Accordingly, the emissivity ε of the busbar 1 can be increased while ensuring conduction between the busbar 1 and the terminals T.

In the busbar 1 according to the present embodiment, the pair of connection portions 111 and the conductor portion 112 are formed in a plate shape, and the plate thickness of the conductor portion 112 is smaller than the plate thickness of the pair of connection portions 111. Accordingly, the area of the cross section of the conductor portion 112 in the direction orthogonal to the current path is smaller than the area of the cross section of the pair of connection portions 111 in the direction orthogonal to the current path, and the weight of the busbar 1 is reduced.

FIG. 10 is a perspective view showing a busbar 2 according to another embodiment of the present disclosure. The busbar 2 shown in this drawing and the busbar 1 according to the embodiment shown in FIG. 1 are different in the configuration of the connection portions 211 and 111. The same components as those of the above-described embodiment shown in FIG. 1 are denoted by the same reference numerals, and the description of the above-described embodiment shown in FIG. 1 is incorporated.

As shown in FIG. 10, in the busbar 2 according to the present embodiment, the connection portion 211 is formed in a U shape. The connection portion 211 includes a pair of connection portions 111 and a coupling portion 211B that couples the pair of connection portions 111. The pair of connection portions 111 face each other.

The terminal T is inserted between the pair of connection portions 111 and fitted to the pair of connection portions 111. A through hole (not shown) into which a bolt (not shown) is inserted is formed in the terminal T, and the connection portion 211 and the terminal T are fastened by the bolt inserted into the through hole 111A and the through hole of the terminal T and a nut (not shown) screwed with the bolt.

The plate thickness of the pair of connection portions 111 is larger than the plate thickness of the conductor portion 112. Further, the alumite treatment is not applied to the contact surfaces of the pair of connection portions 111 with the terminals T, while the alumite treatment is applied to the entire surface of the busbar 2 except for the contact surfaces with the terminals T.

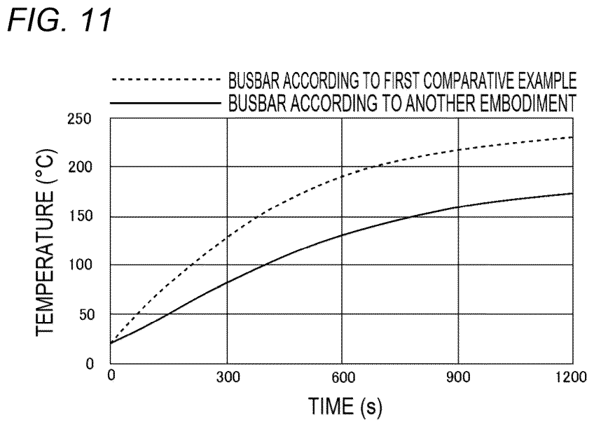

FIG. 11 is a graph showing simulation results of temperature of the busbar 2 shown in FIG. 10 and the temperature of the busbar 1′ according to the first comparative example shown in FIG. 4. In the simulation, the temperature when a current of 800 A was passed through the busbar 2, 1′ for 1200 seconds in an environment of an air temperature of 20° C. was analyzed using the cooling simulation software for electronic components.

From the simulation results shown in FIG. 11, it was confirmed that the busbar 2 shown in FIG. 10 has a higher temperature restriction effect than the busbar 1′ according to the first comparative example shown in FIG. 4.

The present disclosure has been described above based on the above-described embodiments, but the present disclosure is not limited to the embodiments described above, and modifications may be made to the embodiments described above, and publicly known or well-known techniques may be appropriately combined within a scope not departing from the spirit of the present disclosure.

For example, in the above embodiments, the first region A1 in which the heat dissipation fins 12 are provided is a region including the entire conductor portion 112. Alternatively, the conductor portion 112 may have a region in which the heat dissipation fins 12 are not provided. In the above embodiments, the second region A2 including the connection portion 111 outside the first region A1 is limited to the region of the connection portion 111. Alternatively, a part of the conductor portion 112 may be included in the second region A2.

What is claimed is:

1. A busbar comprising:
a pair of connection portions configured to be connected to a connection object;
a conductor portion between the pair of connection portions; and
a heat dissipation fin protruding from the conductor portion,
wherein an area of a cross section orthogonal to a current path in a first region in which the heat dissipation fin is provided is smaller than an area of a cross section orthogonal to the current path in a second region that is outside the first region and includes the connection portions.

2. The busbar according to claim 1,
wherein the pair of connection portions, the conductor portion, and the heat dissipation fin are made of aluminum, and
wherein surfaces of the conductor portion and the heat dissipation fin are subjected to alumite treatment.

3. The busbar according to claim 2,
wherein alumite treatment is performed on surfaces of the pair of connection portions other than a contact surface with the connection object.

4. The busbar according to claim 1,
wherein the pair of connection portions and the conductor portion are formed in a plate shape, and
wherein a plate thickness of the conductor portion is smaller than a plate thickness of the pair of connection portions.

5. The busbar according to claim 2,
wherein the pair of connection portions and the conductor portion are formed in a plate shape, and
wherein a plate thickness of the conductor portion is smaller than a plate thickness of the pair of connection portions.
